(19) United States
(12) Patent Application Publication
(10) Pub. No.: US 2026/0145317 A1
(43) Pub. Date: May 28, 2026

(54) SYSTEMS AND METHODS FOR MANUALLY LEADING A ROBOT

(71) Applicant: COLLABORATIVE ROBOTICS, Santa Clara, CA (US)

(72) Inventors: Brandon Porter, Santa Clara, CA (US); Jon Stevens, Santa Clara, CA (US); Alan Baird, Santa Clara, CA (US); Michael Vogelsong, Santa Clara, CA (US); Siddharth Gupta, Santa Clara, CA (US); Michael Lammers, Santa Clara, CA (US)

(21) Appl. No.: 19/399,303

(22) Filed: Nov. 24, 2025

Related U.S. Application Data
(60) Provisional application No. 63/724,743, filed on Nov. 25, 2024.

(51) Int. Cl. B25J 9/16; B25J 13/02

(52) U.S. Cl. CPC B25J 9/1602; B25J 13/02

(57) ABSTRACT

A robot may include a body, a control system, and a control interface. The control system may be configured to cause the robot to transition between an autonomous mode and an intervention mode. In the autonomous mode, the control system may be configured to autonomously control the body within an environment, In the intervention mode, the control system may be configured to control the body within the environment based on operator input. The control interface may be configured to receive the operator input.

### CROSS-REFERENCE TO RELATED APPLICATION

This patent application claims the benefit of and priority to U.S. Provisional App. No. 63/724,743 filed Nov. 25, 2025, titled “SYSTEMS AND METHODS FOR MANUALLY LEADING A ROBOT,” which is incorporated in the present disclosure by reference in its entirety.

### FIELD

The embodiments discussed in the present disclosure are related to systems and methods for manually leading a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform tasks in various facilities including manufacturing, warehouses, logistics, and delivery settings. Robotics has been useful in making tasks more efficient, thereby improving efficiency and lowering costs to operate the facilities.

Some robots may autonomously operate to perform various tasks. However, there may be situations and/or tasks in which manual intervention or guidance of the robots is beneficial. For example, a robot may encounter an unexpected obstacle or situation in which it is not able to decide how to proceed. As another example, an operator may choose to move the robot to another location or use the robot to perform a task that is out of sequence or that the robot has not been instructed to perform without the operator sending or updating instructions. In such cases, it may be beneficial to have a way for the operator to temporarily take control and manually control the robot.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a robot. The robot may include a body, a control system, and a control interface. The control system may be configured to cause the robot to transition between an autonomous mode and an intervention mode. In the autonomous mode, the control system may be configured to autonomously control the body within an environment. In the intervention mode, the control system may be configured to control the body within the environment based on operator input. The control interface may be configured to receive the operator input.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example operational environment in which a robot may operate in accordance with an autonomous mode and an intervention mode;

FIGS. 2A-2F illustrate examples of the robot of FIG. 1 including different control interfaces;

FIG. 3 illustrates an example train of robots; and

FIG. 4 illustrates an example computing system that may be used to cause a robot to operate in accordance with the autonomous mode and the intervention mode,

all according to at least one embodiment described in the present disclosure.

### DETAILED DESCRIPTION

A robot may receive instructions that specify the operations that are to be completed. The robot may autonomously perform the tasks to complete the operations. There may be situations and/or tasks in which manual intervention or guidance of the robot is beneficial. For example, the robot may come across an unexpected situation or scenario in which the operations cannot be performed. The robot may only be able to operate based on the instructions (e.g., operate in an autonomous mode) and may not be configured to allow the manual intervention (e.g., operate in an intervention mode).

Some robots may only be able to operate based on operator input (e.g., based on an operator manually controlling the robot). Because these robots only operate based on the operator input, they cannot complete operations while an operator is not controlling the robot (e.g., cannot operate in the autonomous mode), which reduces an efficiency of the robots. In addition, these robots may only be able to complete limited operations or operate in limited environments. Therefore, there is a need for a robot that can operate based on the instructions (e.g., operate in the autonomous mode) and operate based on operator input (e.g., operate in an intervention mode) to allow the robot to adapt to dynamic environments or unexpected scenarios and allow manual intervention by the operator.

A robot according to at least one embodiment described in the present disclosure may transition between the autonomous mode and the intervention mode. The robot may include a control system that is configured to control the robot based on the instructions in the autonomous mode. In addition, the control system may determine that an intervention by an operator should occur and cause the robot to transition to the intervention mode. In the intervention mode, the control system may pause autonomous operation of the robot. In addition, in the intervention mode, the control system may control the robot based on operator input.

In one example, the robot may include a body, a control system, and a control interface. The control system may control the robot in accordance with the autonomous mode to autonomously control the robot based on the instructions. The control system may control the robot in accordance with the intervention mode to control the robot based on the operator input.

The control interface may be configured to receive the operator input. The operator input may indicate actions to be taken by the robot in the intervention mode. The control system may control the robot in accordance with the operator input to permit manual operation of the robot (e.g., the control system may facilitate the user manually controlling the robot via the operator input). For example, the operator input may indicate that the robot is to move in a particular direction and the control system may move the robot in accordance with the operator input.

The control system may determine whether the intervention is complete or done and return to the autonomous mode (e.g., return to autonomous operation of the robot). In other words, the control system may cause the robot to perform tasks and/or movements based on the instructions again when the intervention is complete or done. In some embodiments, the control system may determine whether the intervention is complete or done based on the operator input no longer being received by the control interface. In these and other embodiments, the control system may determine that the intervention is complete based on operator input indicating that the intervention is complete or done.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

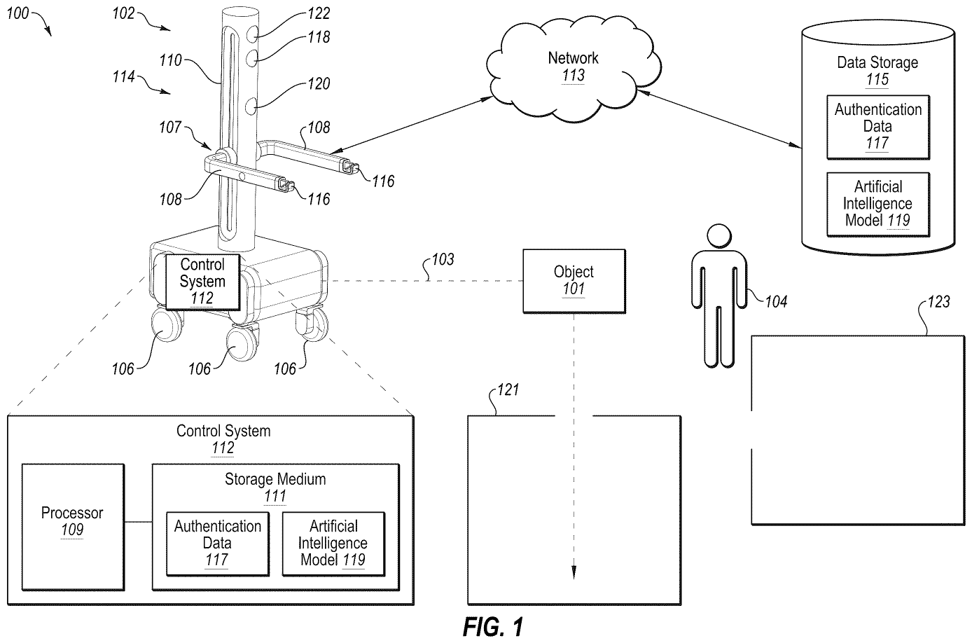

FIG. 1 illustrates an example operational environment 100 in which a robot 102 may operate in accordance with an autonomous mode and an intervention mode, in accordance with at least one embodiment of the present disclosure. In the autonomous mode, the robot 102 may operate autonomously to perform various operations based on instructions. In the intervention mode, the robot 102 may operate based on operator input received from an operator 104.

While operating in the autonomous mode, the robot 102 may come across a scenario in which tasks associated with the operations cannot be performed or are to be performed in a different sequence than indicated in the instructions. For example, as shown in FIG. 1, the robot 102 may traverse a pre-determined route 103 to try and enter a room 121 and an object 101 may block the pre-determined route 103 and access to the room 121. As another example, the robot 102 may traverse the pre-determined route 103 and come upon the object 101 and not be able to determine how to interface with the object 101 to remove it. Additionally or alternatively, the operator 104 may decide to manually control the robot 102 and provide operator input indicating such or the robot 102 may receive instructions indicating manual control is to occur. For example, the robot 102 may receive updated instructions indicating that the operator 104 will manually lead to the robot 102 into another room 123.

The robot 102 may be configured to transition between the autonomous mode and the intervention mode to permit the robot 102 to autonomously operate based on the instructions or to operate based on the operator input. The robot 102 may include a control system 112 that is configured to cause the robot 102 to transition between and operate in accordance with the autonomous mode and the intervention mode.

In the autonomous mode, the control system 112 may autonomously control the robot 102 in accordance with the instructions. The control system 112 may permit intervention by the operator 104 to manually control the robot 102. For example, as described in more detail below, the robot 102 may include a control interface 114 that is configured to receive the operator input. The control interface 114 may operate as an engagement mechanism to receive the operator input. In the intervention mode, the control system 112 may interpret the operator input (e.g., manual control input) received via the control interface 114 to control movement and/or operation of the robot 102.

The robot 102 includes a body 107 that includes wheels 106, arms 108, or a support portion 110. The arms 108 may be coupled to the support portion 110 and may include hands 116. The body 107 may house various internal components such as batteries and actuators (not shown in FIG. 1) to power and/or actuate the robot 102 (not shown in FIG. 1) and/or components (e.g., the arms 108, the hands 116, or the wheels 106) of the robot 102.

The control system 112 may control the body 107 to control the robot 102 within the environment 100. For example, the control system 112 may control the wheels 106 to control the speed, the orientation, or a direction of movement of the robot 102 in the environment 100. Additionally or alternatively, the control system 112 may control the body 107 to cause the robot 102 to interface with the object 101. For example, the control system 112 may control the arms 108, the support portion 110, the hands 116, or some combination thereof to interface with the object 101 (e.g., pickup or release the object 101). In other words, the control system 112 may control the arms 108 and/or the hands 116 to operate as grippers or effectors to interface with the object 101.

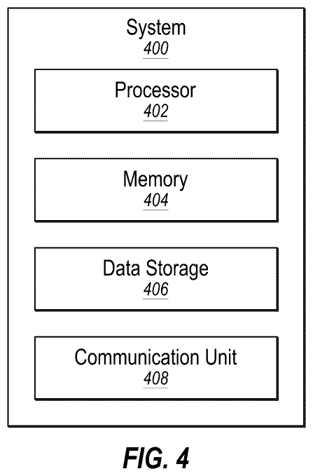

The control system 112 may include a desktop computer, a laptop computer, a smartphone, a mobile phone, a tablet computer, a server, a processing system, or any other computing system or set of computing systems that may be used for performing the operations described in the present disclosure. An example of such a computing system is described below with reference to FIG. 4. The control system 112 may include a processor 109 and a storage medium 111.

The processor 109 may include a central processing unit (CPU), a microprocessor (μP), a microcontroller (μC), a graphics processing unit (GPU), a digital signal processor (DSP), a field-programmable gate array (FPGA), an application-specific integrated circuit (ASIC), or any combination thereof. The processor 109 may be configured to execute computer instructions that, when executed, cause the processor 109 or the control system 112 to operate the robot 102 in accordance with or transition between the autonomous mode and the intervention mode. The processor 109 may be implemented using a combination of hardware and software. In the present disclosure, operations described as being performed by the processor 109 or the control system 112 may include operations that the processor 109 or the control system 112 directs a corresponding system to perform.

The storage medium 111 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The storage medium 111 may store computer instructions that may be executed by the processor 109 or the control system 112 to operate the robot 102 in accordance with or transition between the autonomous mode and the intervention mode. In addition, the storage medium 111 may store an artificial intelligence (AI) model 119, authentication data 117, or both persistently and/or at least temporarily.

The environment 100 may include a data storage 115. The data storage 115 may include any memory or data storage. The data storage 115 may include network communication capabilities such that other components (e.g., 102 or 112) in the environment 100 may communicate with the data storage 115. For example, the control system 112 may obtain the AI model 119, the authentication data 117, or any other appropriate data from the data storage 115. In some embodiments, the data storage 115 may include computer-readable storage media for carrying or having computer-executable instructions or data structures stored thereon. The computer-readable storage media may include any available media that may be accessed by a general-purpose or special-purpose computer, such as a processor. For example, the data storage 115 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 115.

The environment 100 may include a network 113 that includes any communication network configured for communication of signals between any of the components (e.g., 102, 112, or 115) of the environment 100. The network 113 may be wired or wireless. The network 113 may have numerous configurations including a star configuration, a token ring configuration, or another suitable configuration. Furthermore, the network 113 may include a local area network (LAN), a wide area network (WAN) (e.g., the Internet), and/or other interconnected data paths across which multiple devices may communicate. In some embodiments, the network 113 may include a peer-to-peer network. The network 113 may also be coupled to or include portions of a telecommunications network that may enable communication of data in a variety of different communication protocols.

In some embodiments, the network 113 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 113 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 102, 112, or 115) of the environment 100.

The control system 112 may perform an authentication process of the operator 104. The authentication process may include authenticating an identity of the operator 104, an authorization status of the operator 104 to manually control the robot 102, or any other appropriate form of authentication of the operator 104. The control system 112 may prompt the operator 104 for authentication or other credentials. The operator 104 may authenticate themselves or present their credentials to the control system 112 via the control interface 114.

The control interface 114 may include various devices to receive the authentication data 117 from the operator 104 (e.g., credentials) or to otherwise authorize the operator 104. For example, the control interface 114 may include an NFC reader, a biometric scanner, a keypad, or a camera. The control system 112 may use the NFC reader to detect an authorized NFC tag, card, or device. The control system 112 may use the control interface 114 including the biometric scanner to capture the authentication data 117 as a fingerprint, a retina, or other biometric data of the operator 104. The control system 112 may use the keypad to permit the operator 104 to enter the authentication data 117 such as a passcode or personal identification number.

The control system 112 may receive the authentication data 117 including credentials or otherwise authorize the operator 104 based on a pattern of inputs. For example, the control system 112 may identify a specific pattern of inputs detected by a force sensor, a force feedback sensor, or any other appropriate sensor. If the specific pattern corresponds to an identity and/or authorization of a particular person, the control system 112 may authorize the operator 104 to manually control the robot 102. For example, the control system 112 may receive the authentication data 117 which indicates specific patterns of inputs that correspond to authorized operators and compare the specific pattern of inputs detected by the various sensors.

The control system 112 may process the authentication data 117 received from the operator 104 and compare it against a database of authorized operators (e.g., compare it against the authentication data 117 provided by or stored on the data storage 115). If the authentication is successful, the control system 112 may cause the robot 102 to transition to the intervention mode and permit the operator 104 to manually control the robot 102.

In the intervention mode, the control system 112 controls the robot 102 to follow guidance received as the operator input via the control interface 114. For example, the control system 112 controls the wheels 106 based on a magnitude, a level, a direction, or other aspects of the operator input. As another example, the control system 112 controls the support portion 110, the arms 108, or the hands 116 to interface with the object 101 based on the magnitude, the level, the direction, or other aspects of the operator input. In some embodiments, the arms 108 may operate according to multiple degrees of freedom and the operator input may cause the arms 108 to articulate and interface with the object 101.

The robot 102 may include one or more visual indicators 122 such as displays or lights that are incorporated into the body 107. The visual indicators 122 may provide visual feedback regarding operation of the robot 102, such as whether the robot 102 is operating in accordance with the autonomous mode or the intervention mode. The visual indicators 122 may include light emitting diodes (LEDs), a display, or any other appropriate device to indicate the operational aspects of the robot 102. For example, the visual indicators 122 may display a first color when the robot 102 is operating in accordance with the autonomous mode and a second (different) color when the robot 102 is operating in accordance with the intervention mode. As shown in FIG. 1, a single instance of the visual indicators 122 is incorporated in the support portion 110. However, the robot 102 may include any appropriate number of the visual indicators 122 and they may be incorporated in any appropriate portion of the robot 102.

As shown in FIG. 1, the control interface 114 may include an optical sensor 118, an audio sensor 120, or both. The optical sensor 118 or the audio sensor 120 may capture sensor data to permit the robot 102 to detect humans, obstacles, or any other appropriate objects in the environment 100. In other words, the optical sensor 118 and the audio sensor 120 may operate as a computer vision system.

The optical sensor 118 may include one or more cameras and/or video cameras configured to capture image data or video data representative of the operator input (e.g., representative of movements and/or gestures of the operator 104). In some embodiments, the operator input may include hand signals made by the operator 104. For example, the operator input may include a hand signal pointing in a direction to guide the robot 102 to the left. The cameras and/or the video cameras may be positioned at various points on the robot 102 to provide a wide field of view. In some embodiments, the control system 112 may implement image processing algorithms to the image data or the video data to track the movements and/or the gestures of the operator 104.

The audio sensor 120 may include one or more microphones or other audio control interfaces configured to capture audio data representative of the operator input (e.g., representative of verbal commands or verbal instructions provided by the operator 104). In some embodiments, the control system 112 may implement speech recognition algorithms to the audio data to interpret the verbal commands or verbal instructions captured by the audio sensor 120.

The control interface 114 may include a force feedback sensor (not shown in FIG. 1) coupled or otherwise connected to one or more of the actuators of the robot 102. The force feedback sensor may measure a physical input or a displacement characteristic on one more limbs or parts of the robot 102. For example, the force feedback sensor may measure a magnitude, a level, a direction, or other aspects of the operator input when the operator 104 pushes on a part of the robot 102. As a specific example, the robot 102 may be moving in a first direction and the operator 104 may push on one of the arms 108 in a second direction and the force feedback sensor may measure the magnitude, the level, or the direction of the push on one of the arms 108.

The control system 112 may control the robot 102 based on the measured magnitude, level, or direction of the operator input on the part of the robot 102. For example, the control system 112 may cause the robot 102 to move in the direction of the operator input. As another example, the control system 112 may cause the robot 102 to change directions at a rate based on the magnitude of the operator input. As a specific example, the control system 112 may cause the robot 102 to change from moving in the first direction to move in the second direction more quickly when the operator input includes a greater magnitude compared to a lower magnitude.

The AI model 119 may be configured to identify tasks to be performed by the robot 102. For example, in the autonomous mode, the control system 112 may execute the AI model 119 to identify tasks to be autonomously performed by the robot 102 based on the instructions. As another example, in the intervention mode, the control system 112 may execute the AI model 119 to identify tasks to be performed by the robot 102 based on the operator input (e.g., the operator input, the image data, the video data, the audio data, or some combination thereof) or identify obstacles, humans, or other objects in the environment 100 to avoid. In some embodiments, if the operator input indicates that the robot 102 is to collide with an obstacle, human, or other object, the control system 112 may cause the robot 102 to stop operating or otherwise override the operator input.

In the intervention mode, the control system 112 may execute the AI model 119 to identify a set of tasks to be performed by the robot 102 based on the image data, the video data, or the audio data (generally referred to in the present disclosure as the input data). For example, the input data may indicate a series of waypoints that the robot 102 is to move to (e.g., traverse the pre-determined route 103) and the set of tasks may include a series of movements to move the robot 102 to the series of waypoints (e.g., traverse the pre-determined route 103). As another example, the operator input may indicate that the robot 102 is to follow a person and the control system 112 may execute the AI model 119 to determine the set of tasks to cause the robot 102 to follow the person. The control system 112 may cause the robot 102 to perform the set of tasks. Additionally or alternatively, the control system 112 may use the input data to identify and authenticate the operator 104.

The AI model 119 may include at least one of a large language model, a logic model, a rule-based model, a decision tree model, a convolutional neural network model, a linear regression model, a logistic regression model, a supervised learning model, an unsupervised learning model, a deep learning model, or a machine learning model.

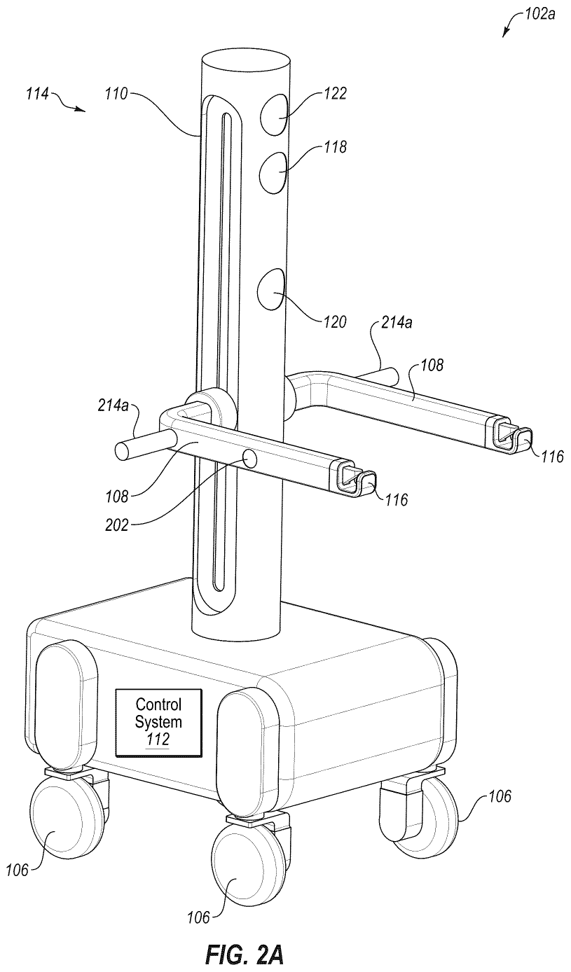

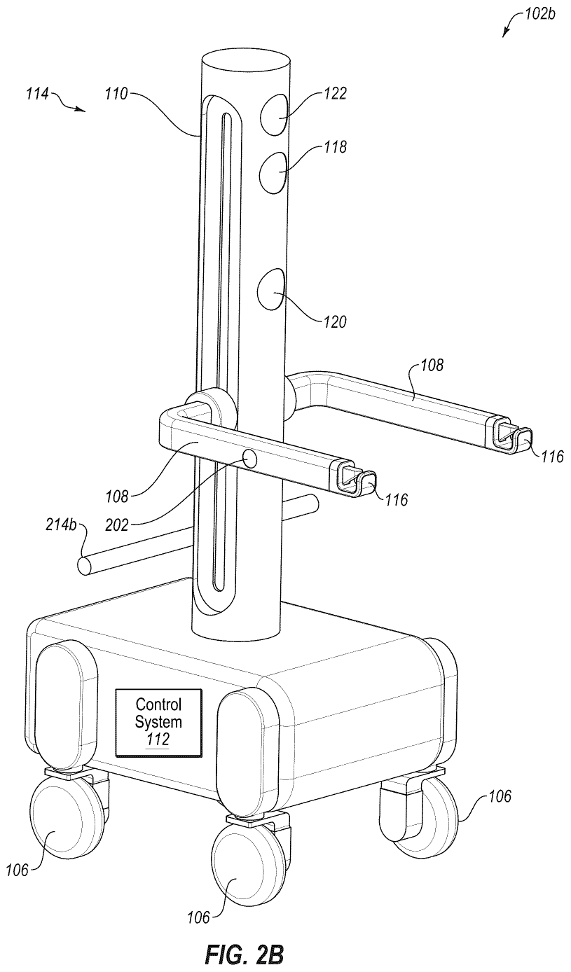

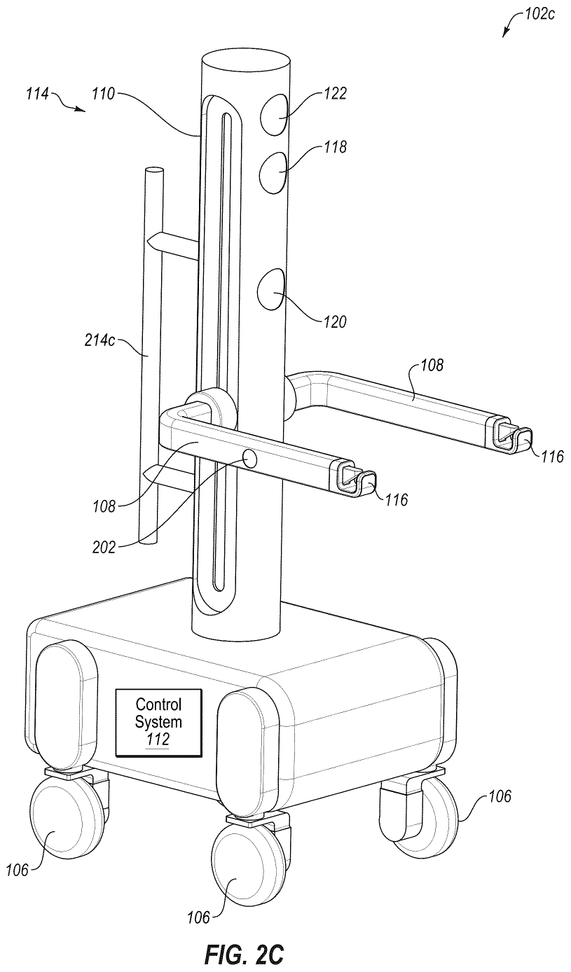

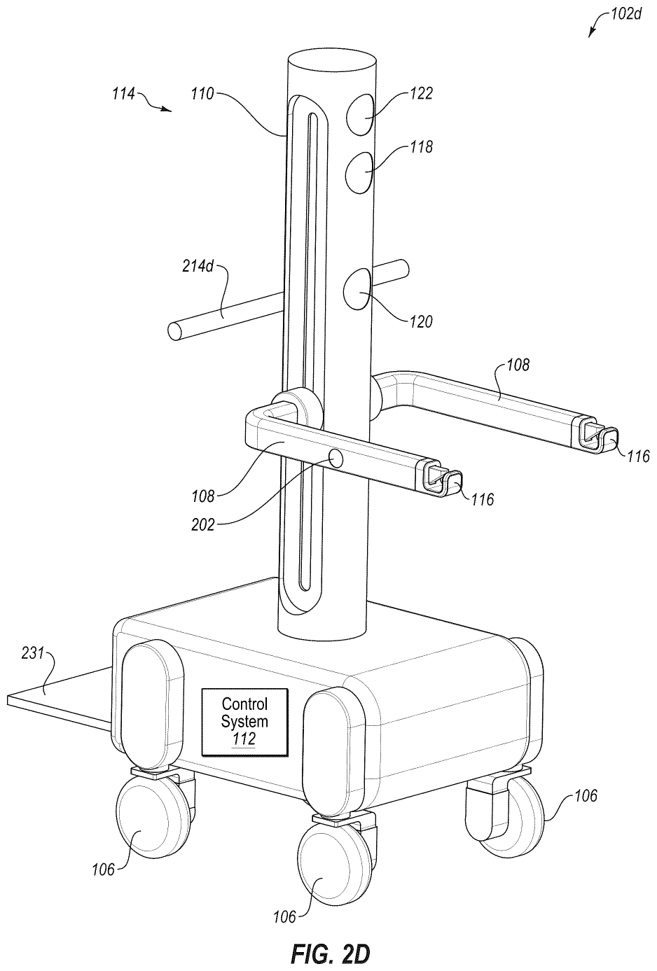

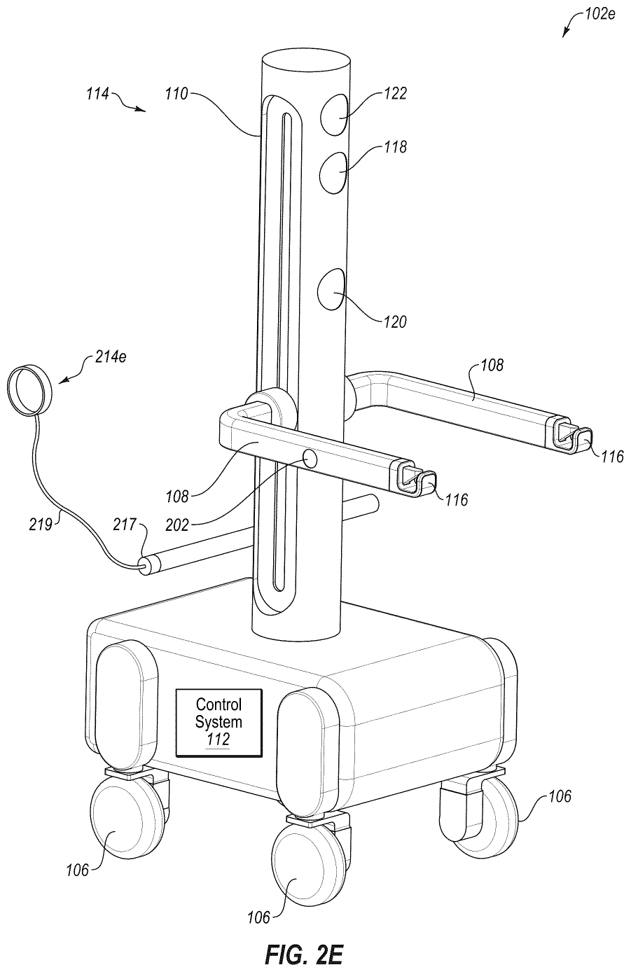

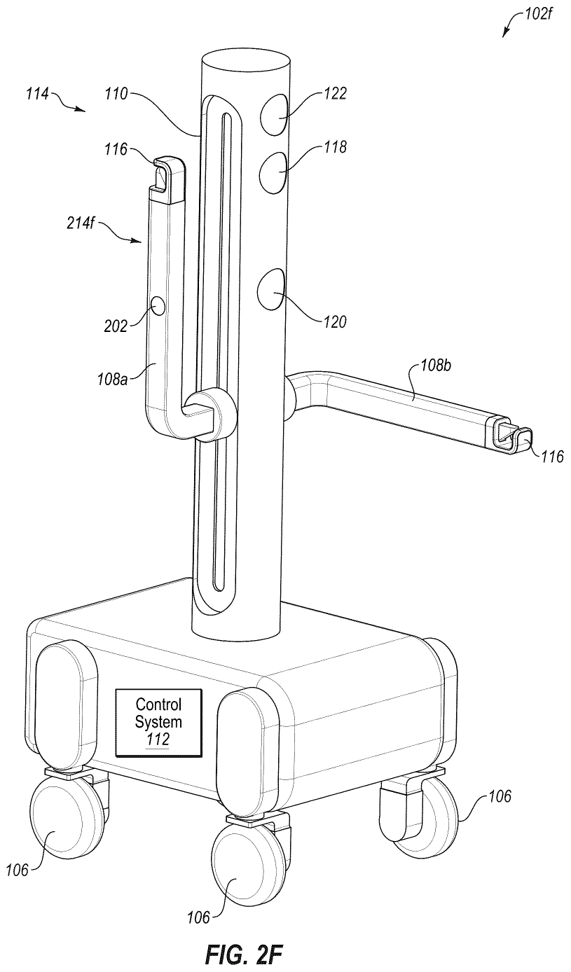

FIGS. 2A-2F illustrate examples of the robot 102 of FIG. 1 in which the control interface 114 includes different types of control interfaces 202 or 214a-f, in accordance with at least one embodiment of the present disclosure.

With combined reference to FIGS. 1-2F, the hands 116 may function as the control interface 114 to receive the operator input. The control interfaces 202 or 214a-f and/or the hands 116 may include physical interface elements that are configured to receive the operator input. The control interface 114 may include a sensor control interface 202 (shown in FIGS. 2A-2E) that includes an input region located on the robot 102 to avoid unintentional contact. The sensor control interface 202 may operate as the engagement mechanism to instruct the control system 112 to cause the robot 102 to operate in accordance with the autonomous mode or the intervention mode. The sensor control interface 202 is illustrated in FIGS. 2A-2E as being located on the arm 108 for example purposes. However, the sensor control interface 202 may be positioned anywhere on the robot 102 or the robot 102 may include multiple instances of the sensor control interface 202.

The sensor control interface 202 may include a force sensor, a pressure sensor, a keypad, a capacitive sensor, or any other appropriate control interface. The sensor control interface 202 may measure a physical input or displacement characteristics due to the operator input and amount of pressure or force of the operator input or any other appropriate aspect of the operator input. The control system 112 may interpret the contact of the operator input to control operation of the robot 102. For example, the control system 112 may cause the robot 102 to move faster when the amount of force applied by the operator input increases. As another example, the sensor control interface 202 may measure an electrostatic field due to the operator input and the control system 112 may control the robot 102 based on the change in the electrostatic field.

When the sensor control interface 202 comprises a touch, a force, a pressure, or a capacitive sensor, the sensor control interface 202 may detect when the operator contacts the sensor control interface 202.

The hands 116 may receive the operator input indicating that the robot 102 is to transition to the intervention mode. Additionally or alternatively, the hands 116 may operate as the control interface to receive the operator input to manually control the robot 102. The hands 116 may receive the operator input as a push or pull action to guide the direction, the orientation, and/or speed of the robot 102.

With reference to FIG. 2A, the control interface 114 of the example robot 102a includes a first control interface 214a. In some embodiments, the sensor control interface 202 may be omitted. The first control interface 214a may include a handlebar extending from the arm 108 (e.g., extending from the elbow of the robot 102a). The first control interface 214a may be rigidly attached to the arm 108. The first control interface 214a is illustrated as extending from one arm 108 of the robot 102a for example purposes. In addition, the first control interface 214a may be positioned anywhere on the arm 108. The control interface 114 may include multiple instances of the first control interface 214a, which may extend from the arms 108 or any other appropriate part of the robot 102a.

The arm 108 may include one or more rotational joints (not shown in FIG. 2A) to which the first control interface 214a may be coupled. These rotational joints may allow the first control interface 214a to pivot relative to the arm 108 to allow the first control interface 214a to operate as the engagement mechanism. For example, these rotational joints may allow the first control interface 214a to transition between a vertical position (not shown in FIG. 2A) that corresponds to the autonomous mode and a horizontal position (shown in FIG. 2A) that corresponds to the intervention mode.

With reference to FIG. 2B, the control interface 114 of the example robot 102b includes a second control interface 214b. In some embodiments, the sensor control interface 202 may be omitted. The second control interface 214b may include a handlebar connected to the support portion 110. The second control interface 214b may extend along a generally horizontal plane relative to the robot 102b.

The support portion 110 may include one or more movable portions (not shown in FIG. 2B) to which the second control interface 214b is coupled. The movable portions may allow the second control interface 214b to move relative to the support portion 110 to allow the second control interface 214b to operate as the engagement mechanism. For example, the movable portions may allow the second control interface 214b to move between a raised position (not shown in FIG. 2B) that corresponds to the autonomous mode and a lowered position (as shown in FIG. 2B) that corresponds to the intervention mode.

With reference to FIG. 2C, the control interface 114 of the illustrated example robot 102c includes a third control interface 214c. In some embodiments, the sensor control interface 202 may be omitted. The third control interface 214c may include a handlebar connected to the support portion 110. The third control interface 214c may extend along a generally vertical plane relative to the robot 102c.

The support portion 110 may include one or more movable portions (not shown in FIG. 2C) to which the third control interface 214c is coupled. The movable portions may allow at least a portion of the third control interface 214c to pivot relative to the support portion 110 to allow the third control interface 214c to operate as the engagement mechanism. For example, the moveable portions may allow the third control interface 214c to move between a raised position (not shown in FIG. 2C) that corresponds to the autonomous mode and a lowered position (as shown in FIG. 2C) that corresponds to the intervention mode.

With reference to FIG. 2D, the control interface 114 of the example robot 102d includes a fourth control interface 214d. In some embodiments, the sensor control interface 202 may be omitted. The fourth control interface 214d may include a handlebar connected to the support portion 110. The fourth control interface 214d may extend along a generally horizontal plane relative to the robot 102d.

The support portion 110 may include one or more movable portions (not shown in FIG. 2D) to which the fourth control interface 214d is coupled. The movable portions may allow the fourth control interface 214d to move relative to the support portion 110 to allow the fourth control interface 214d to operate as the engagement mechanism. For example, the movable portions may allow the fourth control interface 214d to move between a raised position (not shown in FIG. 2D) that corresponds to the autonomous mode and a lowered position (shown in FIG. 2D) that corresponds to the intervention mode.

The robot 102d may include a footpad 231 configured to interface with feet of the operator 104. The robot 102d may transport the operator 104 in the intervention mode using the fourth control interface 214d and the footpad 231. The footpad 231 may include a platform, one or more pegs, a plate, or any other appropriate device to permit the operator 104 to mount the robot 102d. The footpad 231 may include wheels (not shown in FIG. 2D) to support the weight of the operator 104. The footpad 231 may include a weight sensor to permit the footpad 231 to operate as part of the engagement mechanism.

With combined reference to FIGS. 1-2D, the control interface 114 may provide physical interfaces for manual control of the robot 102 by the operator 104. The control interface 114 may include one or more sensors for detecting the operator input. These sensors may include force sensors, pressure sensors, capacitive sensors, displacement sensors, or some combination thereof.

The control interface 114 may detect the various aspects of the operator input. For example, the control interface 114 may detect an amount of force applied by the operator input, an amount of pressure applied by the operator input, a change in electrostatic fields of the control interface 114 due to the operator input, or any other appropriate aspect of the operator input. As another example, the sensors may detect the operator input as a push or a pull action and may detect the amount of force applied on the control interface 114 by the push or pull actions. Additionally or alternatively, the control interface 114 may detect when the operator 104 grasps or touches the control interface 114 (e.g., detects a change in the electrostatic field of the control interface 114) or a position of a hand of the operator 104 on the control interface 114.

The control interfaces 214a-d may be ergonomically shaped to provide a comfortable grip for the operator 104. For example, the control interfaces 214a-d may have a cylindrical cross-section with a diameter suitable for grasping by a human hand. The length of the control interfaces 214a-d may be sufficient to accommodate two-handed operation if desired.

In operation, the operator 104 may touch or grasp the control interface 114, which may detect the operator's touch or grip, and the forces applied. The control system 112 may interpret these inputs to determine the movements for the robot 102 and then the control system 112 may actuate the appropriate motors in the robot 102 to cause the robot 102 to follow the manual control.

With reference to FIG. 2E, the control interface 114 of the example robot 102e includes the control interface 114 and a fifth control interface 214e. In some embodiments, the sensor control interface 202 may be omitted. The fifth control interface 214e may include a tether 219 which may include a leash, a cabled joystick, or any other appropriate device that is configured to attach to the robot 102e.

The fifth control interface 214e may include an attachment point 217 that is connected to the support portion 110. The tether 219 may connect to the attachment point 217. If the tether 219 is disconnected from the attachment point 217, the robot 102e may operate in accordance with the autonomous mode. Connecting the tether 219 to the attachment point 217 may cause the robot 102e to transition to the intervention mode.

The control system 112 may detect the tether 219 (e.g., via NFC or the control interface 114) is within proximity of the robot 102e before it connects to the attachment point 217. The control system 112 may authenticate the operator 104 based on detecting the tether 219.

In operation, the operator 104 may grasp the fifth control interface 214e. The operator 104 may pull on the tether 219 and the control system 112 may detect the forces applied to the fifth control interface 214e. The control system 112 may interpret these inputs to determine the movements for the robot 102e and then the control system 112 may actuate the appropriate motors in the robot 102e to cause the robot 102e to follow the manual control.

With reference to FIG. 2F, the control interface 114 of the illustrated example robot 102 includes a sixth control interface 214f. In some embodiments, the sensor control interface 202 may be omitted. The sixth control interface 214f may include a portion or the entire arms 108a-b of the robot 102f. The arms 108a-b may operate as the engagement mechanism to indicate that the intervention is to occur or the robot 102f is to operate in accordance with the autonomous mode. For example, when both of the arms 108a-b are in a horizontal position (e.g., an autonomous position/the position of the arm 108b shown in FIG. 2F), the robot 102f may operate in the autonomous mode. Moving one or both of the arms 108a-b to a vertical position (e.g., a manual position/the position of the arm 108a shown in FIG. 2F) may indicate that the intervention is to occur and the control system 112 is to cause the robot 102f to transition to the intervention mode.

The control system 112 may detect the operator 104 is proximate the robot 102f and/or authorized to manually control the robot 102f. The control system 112 may automatically change the position of one or more of the arms 108a-b to receive the operator input.

The arms 108a-b, in the intervention mode, may operate as a joystick to receive the operator input. For example, the operator input may include push or pull actions and the control system 112 may control the robot 102f accordingly. In operation, the operator 104 may grasp the arm 108a and push or pull on the arm 108a. The control system 112 may detect the forces applied to the arm 108a and may interpret these inputs to determine the movements for the robot 102f. The control system 112 may actuate the appropriate actuators in the robot 102f to control the robot 102f.

Returning to FIG. 1, the control system 112 may override the instructions based on the operator input. For example, the instructions may indicate that the robot 102 is not to traverse a particular area in the environment 100 (e.g., a hallway) and the operator input may indicate that the robot 102 is to traverse that area and the control system 112 may disregard the operator input to follow the instructions. As another example, the instructions may indicate that the robot 102 is not to interface with a particular type of object but the operator input may indicate that the robot 102 is to interface with the particular type of object and the control system 112 may override the instructions and cause the robot 102 to interface with the particular type of object based on the operator input.

The control system 112 may override or not override the instructions based on an identity of the operator 104 or other safety protocols. For example, the control system 112 may identify/authenticate the operator 104 and a clearance of the operator 104 and if the clearance is of a high enough level, the control system 112 may override the instructions based on the operator input. The control system 112 may determine an authorization level of the operator 104 based on their identity. Additionally, the control system 112 may determine whether or not to override parts or all the operator input based on the authorization level. For example, the authorization level may indicate that the operator 104 is authorized to fully control the robot 102 and the control system 112 may not override any of the operator input. As another example, the authorization level may indicate that the operator 104 is authorized to only control a direction of the robot 102 and the control system 112 may override operator input that tries to cause the robot 102 to interface with the object 101.

The control system 112 may determine a type of the operator input. The control system 112 may determine whether or not to override parts or the entire operator input based on at least one of the identity of the operator 104, the authorization level of the operator 104, or a type of the operator input. For example, the authorization level may indicate that the operator 104 is authorized to only provide input that indicates a series of waypoints, and the type of input may be a twist, a push, or a pull type input and the control system 112 may override the operator input.

The control system 112 may identify the operator 104, determine a type of the operator input, determine a safety protocol, or some combination thereof. The control system 112 may determine the safety protocol based on an aspect of the environment 100. For example, the robot 102 may be proximate to a ledge, a slope, or any other obstacle or feature of the environment 100 and the safety protocol may indicate that the robot 102 should not get closer. The control system 112 may determine whether or not to override parts or all the operator input based on the identity of the operator 104, the type of operator input, or the safety protocol. For example, the type of operator input may not be authorized as a type to override the safety protocol and the control system 112 may override parts or all the operator input. As another example, the type of operator input may be authorized as an authorization type to override the safety protocol and the control system 112 may cause the robot 102 to operate in accordance with the operator input. As a specific example, the type of the operator input may include a push on the arms 108 and the control system 112 may override the operator input based on a push not being an authorized type of operator input to override the safety protocol. Continuing with this example, the type of the operator input may include grabbing a handle and the control system 112 may override the safety protocol based on the operator input received via the handle being an authorized type of operator input to override the safety protocol.

If tasks to be performed by the robot 102 are unclear or if the robot 102 stops receiving the operator input, the robot 102 may default to a stationary state in which the robot 102 does not move. If the robot 102 stops receiving the operator input, the robot 102 may automatically return to the tasks and/or the autonomous mode and continue to operate in accordance with the instructions.

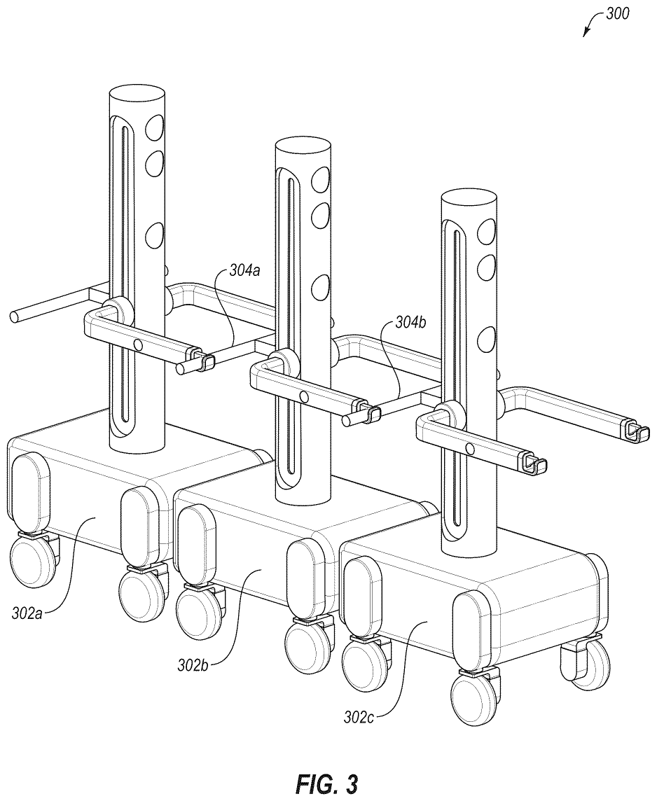

FIG. 3 illustrates an example train 300 of robots 302a-c, in accordance with at least one embodiment of the present disclosure. One or more of the robots 302a-c may include control interfaces 304a-b. The robots 302a-c may correspond to or include the example robot 102b described above in relation to FIG. 2B.

The robots 302a-c may interface with the control interfaces 304a-b to manually control the other robots 302a-c. As shown in FIG. 3, the robot 302a interfaces with the control interface 304a of the robot 302b and the robot 302b interfaces with the control interface 304b of the robot 302c. The operator input may include input provided by the other robots 302a-c. For example, the robot 302a may provide operator input to the robot 302b via the control interface 304b and the robot 302b may provide operator input to the robot 302c via the control interface 304b.

The robots 302a-c are shown as including the control interfaces 304a-b that are handlebars that extend along a generally horizontal plane for example purposes. The robots 302a-c may include any appropriate control interface to permit the robots 302a-c that allows the robots 302a-c to interface with each other. For example, the robots 302a-c may include the sensor control interface 202 and/or one or more of the control interfaces 114, 214a-f described above in relation to FIGS. 1-2D.

FIG. 4 illustrates an example computing system 400 that may be used for the robot 102 and/or the control system 112 described in the present disclosure. The computing system 400 may be configured to implement or direct one or more operations associated with operations of the robot 102, which may include operations of the control system 112, the robot 102, or both. The computing system 400 may include a processor 402, a memory 404, a data storage 406, and a communication unit 408, which all may be communicatively coupled. The computing system 400 may be part of any of the systems or devices described in this disclosure. For example, the computing system 400 may be configured to perform one or more of the tasks described above with respect to the control system 112 and/or the robot 102.

The processor 402 may include any computing entity, or processing device including various computer hardware or software modules and may be configured to execute instructions stored on any applicable computer-readable storage media. For example, the processor 402 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 402 may include any number of processors distributed across any number of networks or physical locations that are configured to perform individually or collectively any number of operations described herein.

In some embodiments, the processor 402 may be configured to interpret and/or execute program instructions and/or process data stored in the memory 404, the data storage 406, or the memory 404 and the data storage 406. In some embodiments, the processor 402 may fetch program instructions from the data storage 406 and load the program instructions in the memory 404. After the program instructions are loaded into memory 404, the processor 402 may execute the program instructions.

For example, in some embodiments, the processor 402 may be configured to interpret and/or execute program instructions and/or process data stored in the memory 404, the data storage 406, or the memory 404 and the data storage 406. The program instruction and/or data may be related to operating in accordance with the autonomous mode and/or the intervention mode such that the computing system 400 may perform or direct the performance of the operations associated therewith as directed by the instructions.

The memory 404 and the data storage 406 may include computer-readable storage media or one or more computer-readable storage mediums for carrying or having computer-executable instructions or data structures stored thereon. Such computer-readable storage media may be any available media that may be accessed by a computer, such as the processor 402.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 402 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500F.3 d 1346 (Fed. Cir. 2007). Combinations of the above may also be included within the scope of computer-readable media.

The communication unit 408 may include any component, device, system, or combination thereof that is configured to transmit or receive information over a network. In some embodiments, the communication unit 408 may communicate with other devices at other locations, the same location, or even other components within the same system. For example, the communication unit 408 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 408 may permit data to be exchanged with a network and/or any other devices or systems described in the present disclosure.

Modifications, additions, or omissions may be made to the computing system 400 without departing from the scope of the present disclosure. For example, in some embodiments, the computing system 400 may include any number of other components that may not be explicitly illustrated or described. Further, depending on certain implementations, the computing system 400 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A robot comprising:
a body;
a control system configured to cause the robot to transition between an autonomous mode and an intervention mode, wherein:
in the autonomous mode, the control system is configured to autonomously control the body within an environment; and
in the intervention mode, the control system is configured to control the body within the environment based on operator input; and
a control interface configured to receive the operator input.

2. The robot of claim 1, wherein:
the body comprises wheels;
in the autonomous mode, the control system is configured to autonomously control the wheels to control a speed, orientation, or a direction of movement of the body in the environment; and
in the intervention mode, the control system is configured to control the wheels to control the speed, the orientation, or the direction of the movement of the body in the environment based on the operator input.

3. The robot of claim 1, wherein the control system is configured to control the body such that at least one of:
the robot moves within an environment; or
the body interfaces with an object in the environment.

4. The robot of claim 1, wherein the control interface comprises:
a handlebar extending from an arm of the body, the handlebar configured to receive the operator input as a push or a pull action; and
in the intervention mode, the control system is configured to control operation of the body based on the push or the pull action of the operator input.

5. The robot of claim 1, wherein:
the control interface comprises a pressure sensor connected to an arm of the body, the pressure sensor configured to detect displacement characteristics of the operator input; and
in the intervention mode, the control system is configured to control operation of the body based on the displacement characteristics of the operator input.

6. The robot of claim 1, wherein:
the control interface comprises a force sensor connected to an arm of the body, the force sensor configured to detect an amount of force applied by the operator input; and
in the intervention mode, the control system is configured to control operation of the body based on the amount of force applied by the operator input.

7. The robot of claim 1, wherein:
the control interface comprises a hand of the body, the hand configured to receive the operator input as a twist, a push, or a pull action; and
in the intervention mode, the control system is configured to control operation of the body based on the twist, the push, or the pull action of the operator input.

8. The robot of claim 1, wherein:
the control interface comprises an arm of the body, the arm configured to receive the operator input to cause the arm to transition between an autonomous position and a manual position, in the manual position the arm is configured receive the operator input as a twist, a push, or a pull action; and
in the intervention mode, the control system is configured to control operation of the body based on the twist, the push or the pull action of the operator input.

9. The robot of claim 1, wherein:
the control interface comprises a handlebar extending form the body, the handlebar configured to receive the operator input as a twist, a push, or a pull action; and
in the intervention mode, the control system is configured to control operation of the body based on the twist, the push or the pull action of the operator input.

10. The robot of claim 1, wherein:
the control interface is configured to connect to the body;
when the control interface is disconnected from the body, the control system causes the robot to operate in accordance with the autonomous mode; and
when the control interface is connected to the body, the control system causes the robot to transition to operating in accordance with the intervention mode.

11. The robot of claim 1, wherein:
the control interface comprises an optical sensor configured to capture image data or video data representative of the operator input;
the control interface comprises an audio sensor configured to capture audio data representative of the operator input; and
the control system comprises:
one or more computer readable media configured to store instructions; and
a processor coupled to the computer readable media, the processor configured to execute the instructions to cause or direct the robot to perform operations, the operations comprising:
obtaining an artificial intelligence (AI) model configured to identify tasks to be performed by the robot within the environment;
identifying, using the AI model, a set of tasks to be performed by the robot based on at least one of the image data, the video data, or the audio data; and
causing the robot to perform the set of tasks.

12. The robot of claim 11, wherein the AI model comprises at least one of a large language model, a logic model, a rule-based model, a decision tree model, a convolutional neural network model, a linear regression model, a logistic regression model, a supervised learning model, an unsupervised learning model, a deep learning model, or a machine learning model.

13. The robot of claim 11, wherein the image data or the video data is representative of at least one of a movement, a gesture, or a hand signal of an operator.

14. The robot of claim 1, wherein:
the control interface comprises a force feedback sensor configured to measure a physical input or displacement characteristics due to the operator input; and
in the intervention mode, the control system is configured to control operation of the body based on the measured physical input or displacement characteristics due to the operator input.

15. The robot of claim 1, wherein at least one of:
the control interface is configured to interface with another robot to receive the operator input from the another robot; or
the body is configured to interface with a control interface of another robot to provide operator input to the another robot via the control interface of the another robot.

16. The robot of claim 1, wherein:
the body comprises a footpad configured to interface with feet of an operator;
the control interface comprises a handle configured to interface with hands of the operator; and
the robot is configured to transport the operator within an environment.

17. The robot of claim 1, wherein the control system is configured to:
identify an operator providing the operator input;
determine an authorization level of the operator based on their identity; and
override at least part of the operator input based on the authorization level of the operator.

18. The robot of claim 1, wherein the control system is configured to:
identify an operator providing the operator input;
determine an authorization level of the operator based on their identity;
determine a type of the operator input; and
override at least part of the operator input based on the authorization level of the operator and the type of the operator input.

19. The robot of claim 1, wherein the control system is configured to:
identify an operator providing the operator input;
determine a type of the operator input;
determine a safety protocol based on an aspect of the environment; and
override at least part of the operator input based on the safety protocol and the type of the operator input.

20. The robot of claim 1, wherein the control system is configured to:
identify an operator providing the operator input;
determine a type of the operator input;
determine a safety protocol based on an aspect of the environment;
override at least part of the operator input based on the type of the operator input; and
override the safety protocol based on the type of the operator input being an authorization type.
